(19) United States
(12) Patent Application Publication
(10) Pub. No.: US 2013/0162394 A1
(43) Pub. Date: Jun. 27, 2013

(54) DATA REPOSITORY AUTHENTICATION

(71) Applicant: NetAuthority, Inc., San Francisco, CA (US)

(72) Inventor: Craig S. ETCHEGOYEN, Newport Beach, CA (US)

(73) Assignee: NETAUTHORITY, INC., San Francisco, CA (US)

(21) Appl. No.: 13/692,843

(22) Filed: Dec. 3, 2012

Related U.S. Application Data
(60) Provisional application No. 61/565,934, filed on Dec. 1, 2011.

(51) Int. Cl. G06F 21/32

(52) U.S. Cl. CPC G06F 21/32
USPC 340/5.53

(57) ABSTRACT

A data repository grants data access through a computer network only to previously authorized computing devices identified by their digital fingerprint. Digital fingerprint authentication can be used with other, conventional authentication protocols for data repository access. Digital fingerprints of authorized computing devices are received by the data repository from known and trusted computing devices.

This application claims priority to U.S. Provisional Application no. 61/565,934, which was filed on Dec. 1, 2011 and which is fully incorporated herein by reference.

### BACKGROUND OF THE INVENTION

1. Field of the Invention

The present invention relates generally to computer security and, more particularly, methods of and systems for securely authenticating devices for access to a data repository through a computer network.

2. Description of the Related Art

Remote access to one's data is becoming more and more significant in today's business environment. Remote data access is also growing rapidly in personal computing, as hailed in the growth of “cloud computing”.

One of the greatest challenges in remote data access is security. Data is often personal and confidential and highly valued. Data security is therefore a principal concern for remotely stored data. Yet, the very raison d'être of network attached storage is to allow access to data through networks to a requesting device and delivery of the data to a location that is beyond the control of the network attached storage.

A conventional way of ensuring control of remotely stored data is through the use of digital certificates. One of the shortcomings of certificates, however, is that copies of certificates can be kept in many storage locations, making copying and improper use of a certificate a significant risk to security.

### SUMMARY OF THE INVENTION

In accordance with the present invention, a data repository grants data access through a computer network only to previously authorized computing devices identified by their digital fingerprints. Digital fingerprints are much more complex, more tightly coupled to a particular computing device, and more difficult to discover or spoof than are other factors used to authenticate remote computing devices. In addition, since digital fingerprints are generated without user interaction, the use of digital fingerprints adds significant security without increasing user inconvenience.

Digital fingerprint authentication can be used in combination with other, conventional authentication protocols for data repository access. Authentication data associated with a user of a given computing device is associated with a digital fingerprint of the computing device. The requirement of a matching digital fingerprint adds an additional, particularly strong authentication factor to other authentication protocols.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a data repository that authenticates a client computer for remote data access in accordance with one embodiment of the present invention.

FIG. 2 is a transaction diagram illustrating one method of controlling access to data by the data repository of FIG. 1 with respect to the client computer of FIG. 1.

FIG. 3 is a block diagram showing the client computer of FIG. 1 in greater detail.

FIG. 4 is a block diagram showing the data repository of FIG. 1 in greater detail.

FIG. 5 is a transaction diagram illustrating one embodiment according to the invention of a method of data access request by the client computer of FIG. 1 for proper authentication with the data repository of FIG. 1.

FIG. 6 is a transaction diagram illustrating one embodiment of a method of registering the client computer of FIG. 1 with the data repository of FIG. 1, assisted by a server of FIG. 1, for subsequent authentication in the manner shown in FIGS. 2 and 5.

FIG. 7 is a block diagram illustrating one example of a digital fingerprint record of a digital fingerprint registry of the data repository of FIG. 4.

### DETAILED DESCRIPTION

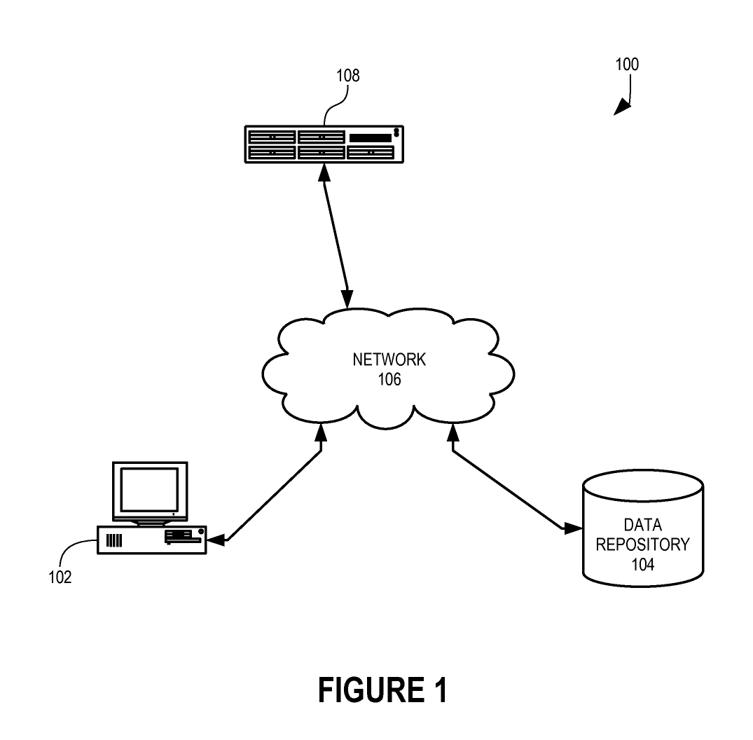

In accordance with the present invention, a data repository 104 limits data access to one or more explicitly authorized devices, e.g., client computer 102 (FIG. 1), identified by their respective digital fingerprints. Data repository 104 can be any type of data server that serves requests for data management from other computing devices, e.g., through a network such as wide area network 106. In this illustrative embodiment, wide area network 106 is the Internet. Examples of data repositories include data stores, data warehouses, and network-attached storage.

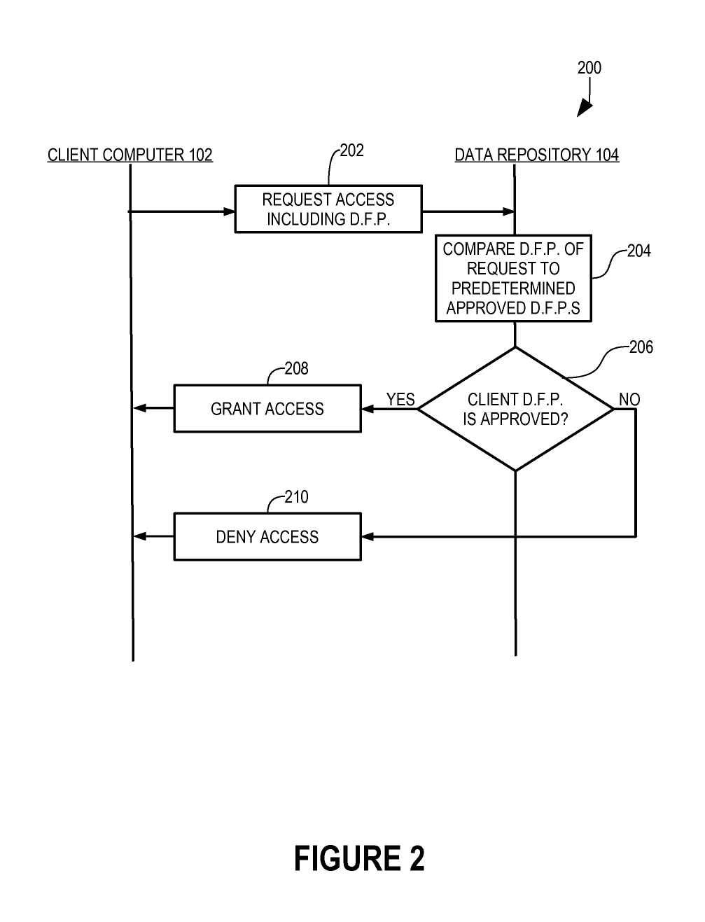

Transaction flow diagram 200 (FIG. 2) illustrates the manner in which data repository 104 controls access to data served by data repository 104, limiting such access to a number of explicitly authorized computing devices. In step 202, client computer 102 requests access to the data served by data repository 104. The request of step 202 includes a digital fingerprint of client device 102, i.e., digital fingerprint 318. Digital fingerprints are known and are described, e.g., in U.S. Pat. No. 5,490,216 (sometimes referred to herein as the '216 Patent), and in U.S. Patent Application Publications 2007/0143073, 2007/0126550, 2011/0093920, and 2011/0093701 (collectively, “the related U.S. Patent Applications”), the descriptions of which are fully incorporated herein by reference.

There are currently a number of conventional authentication protocols for remote data access. Some rely solely on a username-password combination. Others include filters for allowed and denied IP (Internet Protocol) and MAC (Media Access Control) addresses. Such authentication factors are either easily discoverable or dependent upon a human user for security and all are easily spoofed by an unauthorized, malevolent user. By comparison, digital fingerprints are complex, very tightly coupled to a particular computing device, and extremely difficult to discover or spoof. In addition, and perhaps most significant, an advanced class of digital fingerprint is not predetermined by any single manufacturing entity or device supplier. Instead, the advanced digital fingerprint is derived or generated from multiple non-user configurable data strings that originate from various component manufacturers, and/or from user-configurable data entered or created by a user of the device being fingerprinted. In this sense, the advanced digital fingerprint is an “after-market” unique identifier that is derived or generated by a special fingerprinting application that is stored on the device, or that has access to data stored in memory locations on the target device. Accordingly, it is extremely difficult for a computer other than client computer 102 to independently generate or gain access to the digital fingerprint of client computer 102.

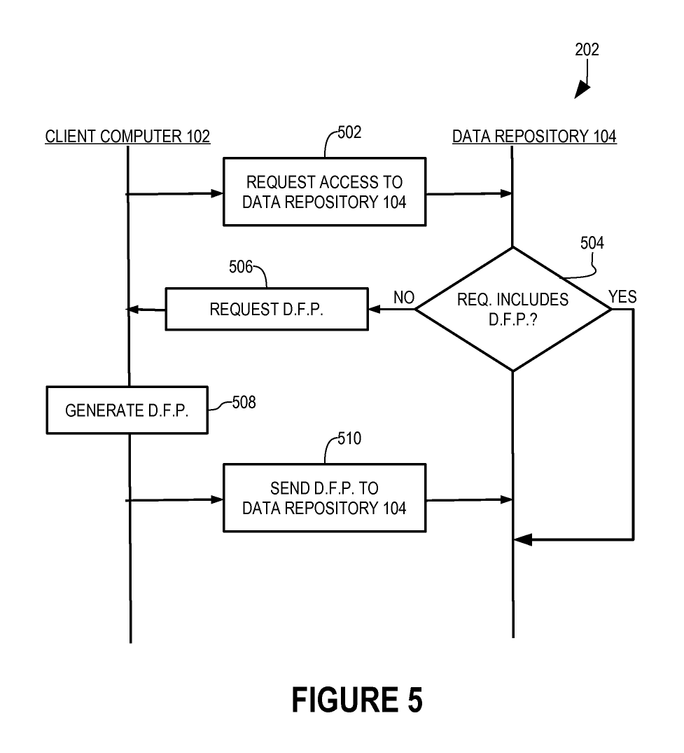

An illustrative embodiment of step 202 is shown as transaction flow diagram 202 (FIG. 5) and is described more completely below.

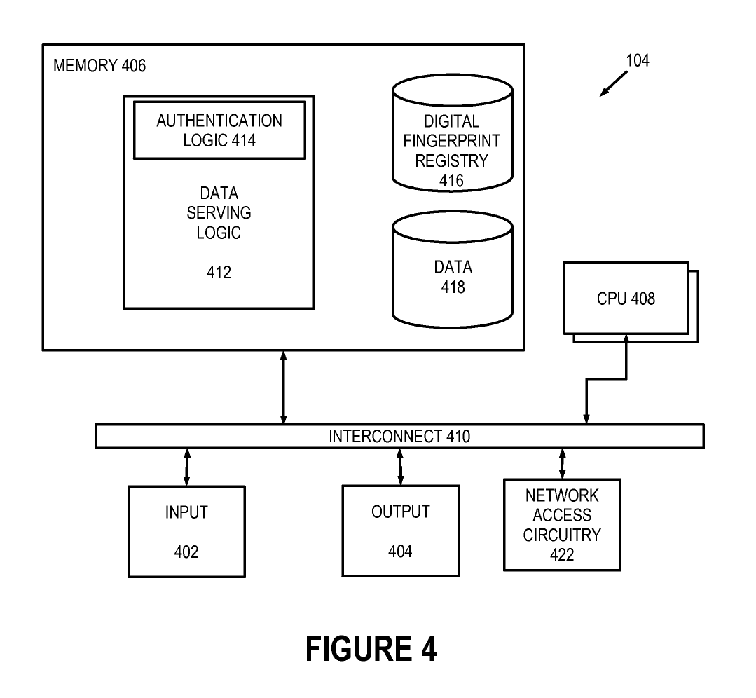

In step 204 (FIG. 2), data repository 104 compares the digital fingerprint of the request received in step 202 to a number of predetermined digital fingerprints representing explicitly authorized devices. As described below, data repository 104 includes data serving logic 412 (FIG. 4), which in turn includes authentication logic 414. Data repository 104 also includes digital fingerprint registry 416, which is used by authentication logic 414 to determine whether to grant or deny requests for access to data 418.

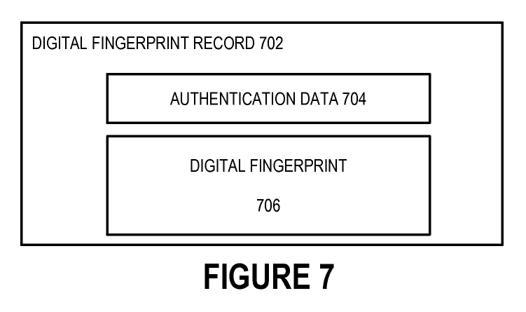

Digital fingerprint registry 416 includes a number of digital fingerprint records, e.g., digital fingerprint record 702 (FIG. 7). Digital fingerprint record 702 includes authentication data 704 and a digital fingerprint 706. Authentication data 704 can include generally any type of conventional authentication data, such as a username-password combination for example. Non-conventional authentication data may also be included in authentication data 704, such as householding data as described in co-pending U.S. Patent Application 61/523,727, which is fully incorporated herein by reference. In embodiments in which a digital fingerprint of client computer 102 is the sole authentication factor, authentication data 704 can be omitted.

In step 204 (FIG. 2), data repository 104 compares the digital fingerprint of the request of step 202 to digital fingerprint 706 of all digital fingerprint records of digital fingerprint registry 416. If additional authentication is required by authentication logic 414, additional authentication data is included in the request of step 202 and authentication logic 414 compares the additional authentication data to authentication data 704 for any digital fingerprint record 702 in which digital fingerprint 706 matches the digital fingerprint of the request of step 202.

In step 206, authentication logic 414 of data repository 104 determines whether the digital fingerprint and any additional authentication data of the request of step 202 matches both authentication data 704 and digital fingerprint 706 of a single digital fingerprint record 702. Authentication logic 414 only grants access for the request of step 202 when matches occur for both authentication data 704 and digital fingerprint 706 of a single digital fingerprint record 702. Matching of digital fingerprints is described in the '216 Patent and the related U.S. Patent Applications and those descriptions are incorporated herein by reference.

If both match, processing by authentication logic 414 transfers to step 208. Otherwise, processing by authentication logic 414 transfers to step 210. In step 208 (FIG. 2), authentication logic 414 of data repository 104 grants client computer 102 (FIG. 1) access to data 418 (FIG. 4). In step 210 (FIG. 2), authentication logic 414 of data repository 104 denies client computer 102 (FIG. 1) access to data 418 (FIG. 4).

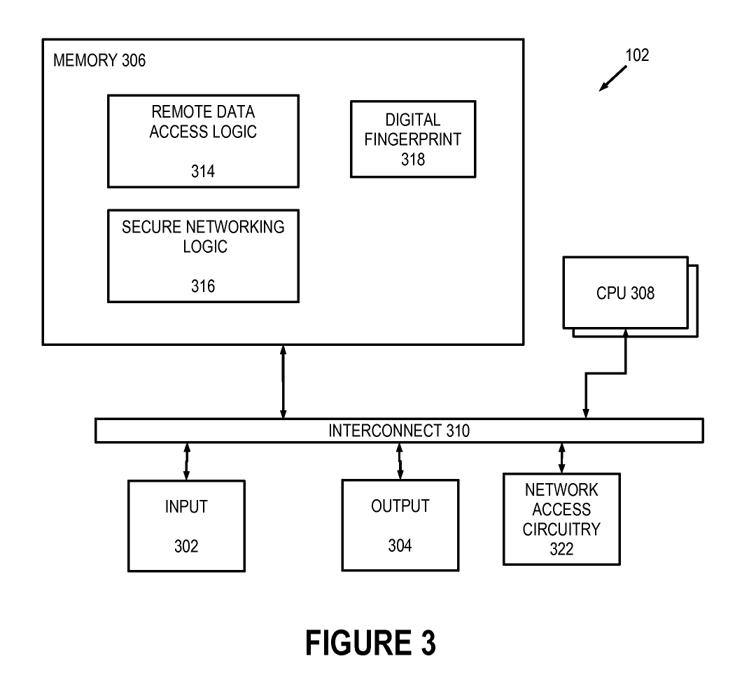

Client computer 102 is shown in greater detail in FIG. 3 and includes one or more microprocessors 308 (collectively referred to as CPU 308) that retrieve data and/or instructions from memory 306 and execute retrieved instructions in a conventional manner. Memory 306 can include generally any computer-readable medium including, for example, persistent memory such as magnetic and/or optical disks, ROM, and PROM and volatile memory such as RAM.

CPU 308 and memory 306 are connected to one another through a conventional interconnect 310, which is a bus in this illustrative embodiment and which connects CPU 308 and memory 306 to one or more input devices 302, output devices 304, and network access circuitry 322. Input devices 302 can include, for example, a keyboard, a keypad, a touch-sensitive screen, a mouse, and a microphone. Output devices 304 can include, for example, a display—such as a liquid crystal display (LCD)—and one or more loudspeakers. Network access circuitry 322 sends and receives data through a wide area network 106 (FIG. 1) such as the Internet and/or mobile device data networks.

A number of components of client computer 102 are stored in memory 306. In particular, remote data access logic 314 and secure networking logic 316 are each all or part of one or more computer processes executing within CPU 308 from memory 306 in this illustrative embodiment but can also be implemented using digital logic circuitry. As used herein, “logic” refers to (i) logic implemented as computer instructions and/or data within one or more computer processes and/or (ii) logic implemented in electronic circuitry. Digital fingerprint 318 is data stored persistently in memory 306.

Remote data access logic 314 can implement any of a number of remote data access protocols, such as NFS (Network File System) and CIFS (Common Internet File System) protocols for example, both of which are known and not described herein in further detail. In addition, secure networking logic 316 can implement any of a number of known Virtual Private Network (VPN) protocols. A common way in which remote data repositories are currently accessed is by, first, establishing a VPN between the client computer and the data repository and, second, using a remote data access protocol, such as CIFS, through the established VPN. The authentication described above with respect to transaction flow diagrams 200 (FIGS. 2) and 202 (FIG. 5) can be implemented by secure networking logic 316, by remote data access logic 314, or both.

Data repository 104 (FIG. 1) is shown in greater detail in FIG. 4 and includes a CPU 408, memory 406, interconnect 410, input devices 402, output devices 404, and network access circuitry 422 that are directly analogous to CPU 308 (FIG. 3), memory 306, interconnect 310, input devices 302, output devices 304, and network access circuitry 322, respectively, of client computer 102. Since data repository 104 (FIG. 4) is a server computer, input devices 402 and output devices 404 can be omitted and data repository 104 can interact with one or more human users exclusively through network access circuitry 422, e.g., through a remote command shell protocol such as the known ‘ssh’ remote command shell protocol.

A number of components of data repository 104 are stored in memory 406. In particular, data serving logic 412, including authentication logic 414, is all or part of one or more computer processes executing within CPU 408 from memory 406 in this illustrative embodiment but can also be implemented using digital logic circuitry. Digital fingerprint registry 416 and data 418 are data stored persistently in memory 406. In this illustrative embodiment, digital fingerprint registry 416 is organized as a database.

Data 418 is the data served by data repository 104 and access to which client computer 102 requests. Data 418 can be a file system or a database or any other collection of data intended to be accessed through a computer network.

Data serving logic 412 can implement remote data access protocols and VPN protocols. To ensure access is limited to previously authorized users, data serving logic 412 includes authentication logic 414 that causes data repository 104 to behave in the manner described herein.

Transaction flow diagram 202 (FIG. 5) shows step 202 (FIG. 2) in greater detail.

In step 502 (FIG. 5), client computer 102 sends a request for access to data 418 (FIG. 4) of data repository 104.

In test step 504 (FIG. 5), authentication logic 414 (FIG. 4) determines whether the request of 502 includes a digital fingerprint of a format that can be processed by authentication logic 414 and stored in digital fingerprint registry 416. If so, processing according to transaction flow diagram 202, and therefore step 202 (FIG. 2), completes, skipping steps 506-510 (FIG. 5).

Conversely, if the request of step 502 does not include a proper digital fingerprint, processing by authentication logic 414 transfers to step 506, in which authentication logic 414 requests a digital fingerprint from client computer 102.

In response to such a request and in step 508, client computer 102 generates a digital fingerprint of itself. In some embodiments, client computer 102 creates the digital fingerprint of itself using logic independently and previously installed in client computer 102. In other embodiments, data repository 104 directs client computer 102 to obtain digital fingerprint generation logic, e.g., from server 108 in the form of an applet, and to then execute the logic to thereby generate a digital fingerprint of client computer 102. In other embodiments, a combination of these methods is used. For example, the fingerprint generating logic may be pre-installed on client computer 102, and in request 506 data repository 104 may include a filter, template, reversible hashing algorithm, or other specific instruction to be used in conjunction with the preinstalled fingerprint generating logic. This way, each time a digital fingerprint is generated in step 508, it may include a variation to provide an added layer of security, so long as such variation may be mapped to a registered digital fingerprint that uniquely identifies the client device and that is stored in the digital fingerprint registry 416. The particular manner in which data repository 104 specifies the logic to be obtained by client computer 102 and the particular manner in which client computer 102 executes the logic are unimportant and there are many known ways for accomplishing each. The generation of a digital fingerprint is described in the '216 Patent and the related U.S. Patent Applications and those descriptions are incorporated herein by reference.

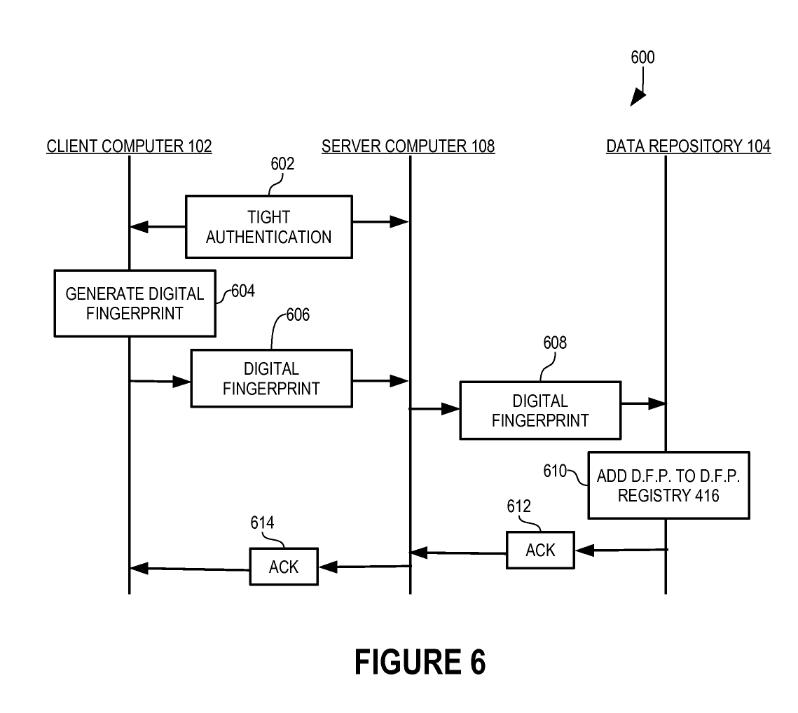

As noted above, client computer 102 is granted access to data 418 if its digital fingerprint (or variation thereof) is represented in digital fingerprint registry 416. Accordingly, digital fingerprint 314 (FIG. 3) of client computer 102 must be added to digital fingerprint registry 416 before client computer 102 can be granted access to data 418, and one manner of doing so is illustrated in transaction flow diagram 600 (FIG. 6).

In transaction flow diagram 600, server computer 108 (FIGS. 1 and 6) is a server computer under control of the same entity that controls data repository 104. Data repository 104 is configured to accept configuration data from server computer 108. In effect, server computer 108 can control the behavior of data repository 104. At least, data repository 104 is configured to trust digital fingerprints received from server computer 108 as properly authorized to access data 418 (FIG. 4). In other embodiments, data repository 104 is configured to accept digital fingerprints from any computing device whose digital fingerprint is already represented in digital fingerprint registry 416 and is therefore authorized to access data 418. In yet other embodiments, data repository 104 includes logic that performs the steps that server computer 108 performs in the embodiment illustrated in transaction flow diagram 600 (FIG. 6).

In step 602 (FIG. 6), server computer 108 authenticates client computer 102 as a computing device that should be authorized to access data 418 (FIG. 4) through data repository 104. Particularly tight and secure authentication is preferred since the one transaction of transaction flow diagram 600 gives client computer 102 lasting authority to access data 418 repeatedly. In addition, since the transaction of transaction diagram 600 is required only once, particularly secure, multiple-factor authentication for this one transaction is not particularly onerous or inconvenient. In one extreme example, tight authentication may involve physical delivery of a client device to a security center for authentication by authorized personnel.

In step 604, client computer 102 generates its digital fingerprint in the manner described above with respect to step 508 (FIG. 5). In embodiments in which digital fingerprint record 702 (FIG. 7) includes authentication data 704 beyond digital fingerprint 706, client computer 102 (FIG. 6) gathers such authentication data, e.g., from the user using conventional user-interface techniques, in step 604.

In step 606, client computer 102 sends the digital fingerprint generated in step 604, along with any authentication data gathered in step 604, to server computer 108. In step 608, server computer 108 sends the same digital fingerprint and authentication data to data repository 104. In embodiments in which server computer 108 is omitted, the sending of steps 606 and 608 are a single step of sending from client computer 102 to data repository 104.

In step 610, data repository 104 adds the received digital fingerprint and authentication data to digital fingerprint registry 416 (FIG. 4). In particular, authentication logic 414 forms a digital fingerprint record such as digital fingerprint record 702 from the received digital fingerprint and authentication, storing the received digital fingerprint as digital fingerprint 706 and any other authentication data as authentication data 704. After step 610 (FIG. 6), client computer 102 is authorized to access data 418 (FIG. 4) through data repository 104 and will be granted such access in described above with respect to transaction flow diagram 200 (FIG. 2).

In step 612 (FIG. 6), data repository 104 sends acknowledgment to server computer 108 of the successful addition of the received digital fingerprint to digital fingerprint registry 416 (FIG. 4). In step 614, server computer 108 sends an analogous acknowledgment to client computer 102. In embodiments in which server computer 108 is omitted, the acknowledgment of steps 612 and 614 are a single step of acknowledgment from data repository 104 to client computer 102.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for limiting access to a collection of data to one or more authorized computing devices, the method comprising:
receiving a request for access to the collection of data from a remote computing remote through a computer network;
receiving a digital fingerprint of the remote computing device;
retrieving one or more digital fingerprints associated with respective authorized computing devices;
comparing the digital fingerprint of the remote computing device to the digital fingerprints associated with respective authorized computing devices; and
upon a condition in which at least one of the digital fingerprints associated with respective authorized computing devices is matched by the digital fingerprint of the remote computing device, granting the remote computing device access to the collection of data.

2. The method of claim 1 further comprising:
determining that the request does not include the digital fingerprint of the remote computing device; and
requesting a digital fingerprint from the remote computing device.

3. The method of claim 1 further comprising:
receiving authentication data from the remote computing device.

4. The method of claim 3 further comprising:
retrieving authentication data associated with respective authorized computing devices; and
comparing the authentication data from the remote computing device with the authentication data associated with respective authorized computing devices; and
wherein the granting the remote computing device access to the collection of data is performed only upon a condition in which:
the digital fingerprint associated with a selected one of the authorized computing devices is matched by the digital fingerprint of the remote computing device; and
the authentication data associated the selected authorized computing device is matched by the authentication data from the remote computing device.

5. The method of claim 1 further comprising:
receiving the digital fingerprints associated with respective authorized computing devices through a computer network from a trusted computing device.

6. A computer readable medium useful in association with a computer which includes one or more processors and a memory, the computer readable medium including computer instructions which are configured to cause the computer, by execution of the computer instructions in the one or more processors from the memory, to limit access to a collection of data to one or more authorized computing devices by at least:
receiving a request for access to the collection of data from a remote computing remote through a computer network;
receiving a digital fingerprint of the remote computing device;
retrieving one or more digital fingerprints associated with respective authorized computing devices;
comparing the digital fingerprint of the remote computing device to the digital fingerprints associated with respective authorized computing devices; and
upon a condition in which at least one of the digital fingerprints associated with respective authorized computing devices is matched by the digital fingerprint of the remote computing device, granting the remote computing device access to the collection of data.

7. The computer readable medium of claim 6 wherein the computer instructions are configured to cause the computer to limit access to a collection of data to one or more authorized computing devices by also:
determining that the request does not include the digital fingerprint of the remote computing device; and
requesting a digital fingerprint from the remote computing device.

8. The computer readable medium of claim 6 wherein the computer instructions are configured to cause the computer to limit access to a collection of data to one or more authorized computing devices by also:
receiving authentication data from the remote computing device.

9. The computer readable medium of claim 8 wherein the computer instructions are configured to cause the computer to limit access to a collection of data to one or more authorized computing devices by also:
retrieving authentication data associated with respective authorized computing devices; and
comparing the authentication data from the remote computing device with the authentication data associated with respective authorized computing devices; and
wherein the granting the remote computing device access to the collection of data is performed only upon a condition in which:
the digital fingerprint associated with a selected one of the authorized computing devices is matched by the digital fingerprint of the remote computing device; and
the authentication data associated the selected authorized computing device is matched by the authentication data from the remote computing device.

10. The computer readable medium of claim 6 wherein the computer instructions are configured to cause the computer to limit access to a collection of data to one or more authorized computing devices by also:
receiving the digital fingerprints associated with respective authorized computing devices through a computer network from a trusted computing device.

11. A computer system comprising:
at least one processor;
a computer readable medium that is operatively coupled to the processor; and
data repository access control logic (i) that executes in the processor from the computer readable medium and (ii) that, when executed by the processor, causes the computer to limit access to a collection of data to one or more authorized computing devices by at least:
receiving a request for access to the collection of data from a remote computing remote through a computer network;
receiving a digital fingerprint of the remote computing device;
retrieving one or more digital fingerprints associated with respective authorized computing devices;
comparing the digital fingerprint of the remote computing device to the digital fingerprints associated with respective authorized computing devices; and
upon a condition in which at least one of the digital fingerprints associated with respective authorized computing devices is matched by the digital fingerprint of the remote computing device, granting the remote computing device access to the collection of data.

12. The computer system of claim 11 wherein execution of the data repository access control logic causes the computer to limit access to a collection of data to one or more authorized computing devices by also:
determining that the request does not include the digital fingerprint of the remote computing device; and
requesting a digital fingerprint from the remote computing device.

13. The computer system of claim 11 wherein execution of the data repository access control logic causes the computer to limit access to a collection of data to one or more authorized computing devices by also:
receiving authentication data from the remote computing device.

14. The computer system of claim 13 wherein execution of the data repository access control logic causes the computer to limit access to a collection of data to one or more authorized computing devices by also:
retrieving authentication data associated with respective authorized computing devices; and
comparing the authentication data from the remote computing device with the authentication data associated with respective authorized computing devices; and
wherein the granting the remote computing device access to the collection of data is performed only upon a condition in which:
the digital fingerprint associated with a selected one of the authorized computing devices is matched by the digital fingerprint of the remote computing device; and
the authentication data associated the selected authorized computing device is matched by the authentication data from the remote computing device.

15. The computer system of claim 11 wherein execution of the data repository access control logic causes the computer to limit access to a collection of data to one or more authorized computing devices by also:
receiving the digital fingerprints associated with respective authorized computing devices through a computer network from a trusted computing device.
